(19) United States
(12) Patent Application Publication
(10) Pub. No.: US 2023/0394304 A1
(43) Pub. Date: Dec. 7, 2023

(54) Method and Apparatus for Neural Network Based on Energy-Based Latent Variable Models

(71) Applicants: Robert Bosch GmbH, Stuttgart (DE); Tsinghua University, Beijing (CN)

(72) Inventors: Jun Zhu, Beijing (CN); Fan Bao, Beijing (CN); Chongxuan Li, Beijing (CN); Kun Xu, Beijing (CN); Hang Su, Beijing (CN); Siliang Lu, Shanghai (CN)

(21) Appl. No.: 18/248,917

(22) PCT Filed: Oct. 15, 2020
(86) PCT No.: PCT/CN2020/121172

§ 371 Date: Apr. 13, 2023

(51) Int. Cl. G06N 3/08

(52) U.S. Cl. CPC G06N 3/08

(57) ABSTRACT

A method for training neural networks based on energy-based latent variable models (EBLVMs) includes bi-level optimizations based on a score matching objective. The lower-level optimizes a variational posterior distribution of the latent variables to approximate the true posterior distribution of the EBLVM, and the higher-level optimizes the neural network parameters based on a modified SM objective as a function of the variational posterior distribution. The method is used to train neural networks based on EBLVMs with nonstructural assumptions.

### FIELD

The present disclosure relates generally to artificial intelligence techniques, and more particularly, to artificial intelligence techniques for neural networks based on energy-based latent variable models.

### BACKGROUND

An energy-based model (EBM) plays an important role in research and development of artificial neural networks, also simply called neural networks (NNs). An EBM employs an energy function mapping a configuration of variables to a scalar to define a Gibbs distribution, whose density is proportional to the exponential negative energy. EBMs can naturally incorporate latent variables to fit complex data and extract features. A latent variable is a variable that cannot be observed directly and may affect the output response to visible variable. An EBM with latent variables, also called energy-based latent variable model (EBLVM), may be used to generate neural networks providing improved performance. Therefore, EBLVM can be widely used in the fields of image processing, security etc. For example, an image may be transferred into a particular style (such as warm colors) by a neural network learned based on EBLVM and a batch of image with the particular style. For another example, EBLVM may be used to generate a music with a particular style, such as, classic, jazz, or even a style of singer. However, it is challenging to learn EBMs because of the presence of the partition function, which is an integral over all possible configurations, especially when latent variables present.

The most widely used training method is maximum likelihood estimate (MLE), or equivalently minimizing KL divergence. Such methods often adopt Markov chain Monte Carlo (MCMC) or variational inference (VI) to estimate the partition function, and several methods attempt to address the problem of inferring the latent variables by advances in amortized inference. However, these methods may not be well applied to high-dimensional data (such as, image data), since the variational bounds for the partition function are either of high-bias or high-variance. Score matching (SM) method provides an alternative approach to learn EBMs. Compared with MLE, SM does not need to access the partition function because of its foundation on Fisher divergence minimization. However, it is much more challenging to incorporate latent variables in SM than in MLE because of its specific form. Currently, extensions of SM for EBLVMs make strong structural assumptions that the posterior of latent variables is tractable.

Therefore, there exists a strong need for new techniques to train neural networks based on EBLVMs without structural assumption.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect according to the disclosure, a method for training a neural network based on an energy-based model with a batch of training data is disclosed, wherein the energy-based model is defined by a set of network parameters (θ), a visible variable and a latent variable. The method comprises: obtaining a variational posterior probability distribution of the latent variable given the visible variable by optimizing a set of parameters (φ) of the variational posterior probability distribution on a minibatch of training data sampled from the batch of training data, wherein the variational posterior probability distribution is provided to approximate a true posterior probability distribution of the latent variable given the visible variable wherein the true posterior probability distribution is relevant to the network parameters (θ); optimizing network parameters (θ) based on a score matching objective of a marginal probability distribution on the minibatch of training data, wherein the marginal probability distribution is obtained based on the variational posterior probability distribution and an unnormalized joint probability distribution of the visible variable and the latent variable; and repeating the steps of obtaining a variational posterior probability distribution and optimizing network parameters (θ) on different minibatches of the training data, till convergence condition satisfied.

In another aspect according to the disclosure, an apparatus for training a neural network based on an energy-based model with a batch of training data is disclosed, wherein the energy-based model is defined by a set of network parameters (θ), a visible variable and a latent variable, the apparatus comprising: means for obtaining a variational posterior probability distribution of the latent variable given the visible variable by optimizing a set of parameters (φ) of the variational posterior probability distribution on a minibatch of training data sampled from the batch of training data, wherein the variational posterior probability distribution is provided to approximate a true posterior probability distribution of the latent variable given the visible variable wherein the true posterior probability distribution is relevant to the network parameters (θ); means for optimizing network parameters (θ) based on a score matching objective of a marginal probability distribution on the minibatch of training data, wherein the marginal probability distribution is obtained based on the variational posterior probability distribution and an unnormalized joint probability distribution of the visible variable and the latent variable; wherein the means for obtaining a variational posterior probability distribution and the means for optimizing network parameters (θ) are configured to perform repeatedly on different minibatches of training data, till convergence condition satisfied.

In another aspect according to the disclosure, an apparatus for training a neural network based on an energy-based model with a batch of training data, wherein the energy-based model is defined by a set of network parameters (θ), a visible variable and a latent variable, the apparatus comprising: a memory; and at least one processor coupled to the memory and configured to: obtain a variational posterior probability distribution of the latent variable given the visible variable by optimizing a set of parameters (φ) of the variational posterior probability distribution on a minibatch of training data sampled from the batch of training data, wherein the variational posterior probability distribution is provided to approximate a true posterior probability distribution of the latent variable given the visible variable wherein the true posterior probability distribution is relevant to the network parameters (θ); optimize network parameters (θ) based on a score matching objective of a marginal probability distribution on the minibatch of training data, wherein the marginal probability distribution is obtained based on the variational posterior probability distribution and an unnormalized joint probability distribution of the visible variable and the latent variable; and repeat the obtaining a variational posterior probability distribution and the optimizing network parameters (θ) on different minibatches of the training data, till convergence condition satisfied.

In another aspect according to the disclosure, a computer readable medium, storing computer code for training a neural network based on an energy-based model with a batch of training data, wherein the energy-based model is defined by a set of network parameters (θ), a visible variable and a latent variable, the computer code when executed by a processor, causing the processor to: obtain a variational posterior probability distribution of the latent variable given the visible variable by optimizing a set of parameters (φ) of the variational posterior probability distribution on a minibatch of training data sampled from the batch of training data, wherein the variational posterior probability distribution is provided to approximate a true posterior probability distribution of the latent variable given the visible variable wherein the true posterior probability distribution is relevant to the network parameters (θ); optimize network parameters (θ) based on a score matching objective of a marginal probability distribution on the minibatch of training data, wherein the marginal probability distribution is obtained based on the variational posterior probability distribution and an unnormalized joint probability distribution of the visible variable and the latent variable; and repeat the obtaining a variational posterior probability distribution and the optimizing network parameters (θ) on different minibatches of the training data, till convergence condition satisfied. Other aspects or variations of the disclosure will become apparent by consideration

of the following detailed description and accompanying drawings.

### BRIEF DESCRIPTION OF THE DRAWINGS

The following figures depict various embodiments of the present disclosure for purposes of illustration only. One skilled in the art will readily recognize from the following description that alternative embodiments of the methods and structures disclosed herein may be implemented without departing from the spirit and principles of the disclosure described herein.

FIG. 1 illustrates an exemplary structure of a restricted Boltzmann machine based on an EBLVM according to one embodiment of the present disclosure.

FIG. 2 illustrates a general flowchart of a method for training a neural network based on an EBLVM according to one embodiment of the present disclosure.

FIG. 3 illustrates a detailed flowchart of a method for training a neural network based on an EBLVM according to one embodiment of the present disclosure.

FIG. 4 shows natural images of hand-written digits generated by a generative neural network trained according to one embodiment of the present disclosure.

FIG. 5 illustrates a flowchart of method of training a neural network for anomaly detection according to one embodiment of the present disclosure.

FIG. 6 illustrates a flowchart of method of training a neural network for anomaly detection according to another embodiment of the present disclosure.

FIG. 7 illustrates a flowchart of method of training a neural network for anomaly detection according to another embodiment of the present disclosure.

FIG. 8 shows schematic diagrams of probability density distribution and clustering result for anomaly detection trained according to one embodiment of the present disclosure.

FIG. 9 illustrates a block diagram of an apparatus for training a neural network based on an EBLVM according to one embodiment of the present disclosure.

FIG. 10 illustrates a block diagram of an apparatus for training a neural network based on an EBLVM according to another embodiment of the present disclosure.

FIG. 11 illustrates a block diagram of an apparatus for training a neural network for anomaly detection according to various embodiments of the present disclosure.

### DETAILED DESCRIPTION

Before any embodiments of the present disclosure are explained in detail, it is to be understood that the disclosure is not limited in its application to the details of construction and the arrangement of features set forth in the following description. The disclosure is capable of other embodiments and of being practiced or of being carried out in various ways.

Artificial neural networks (ANNs) are computing systems vaguely inspired by the biological neural networks that constitute animal brains. An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it. The “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

A neural network may be implemented by a general processor or an application specific processor, such as a neural network processor, or even each neuron in the neural network may be implemented by one or more specific logic units. A neural network processor (NNP) or neural processing unit (NPU) is a specialized circuit that implements all the necessary control and arithmetic logic necessary to execute machine learning and/or inference of a neural network. For example, executing deep neural networks (DNNs), such as convolutional neural networks, means performing a very large amount of multiply-accumulate operations, typically in the billions and trillions of iterations. A large number of iterations comes from the fact that for each given input (e.g., image), a single convolution comprises of iterating over every channel and then every pixel and performing a very large number of MAC operations. Unlike general central processing units which are great at processing highly serialized instruction streams, machine learning workloads tend to be highly parallelizable, much like a graphics processing unit (GPU). Moreover, unlike a GPU, NPUs can benefit from vastly simpler logic because their workloads tend to exhibit high regularity in the computational patterns of deep neural networks. For those reasons, many custom-designed dedicated neural processors have been developed. NPUs are designed to accelerate the performance of common machine learning tasks such as image classification, machine translation, object detection, and various other predictive models. NPUs may be part of a large SoC, a plurality of NPUs may be instantiated on a single chip, or they may be part of a dedicated neural-network accelerator.

There are many types of neural networks available. They can be classified depending on their: Structure, Data flow, Neurons used and their density, Layers and their depth activation filters etc. Most of the neural networks may be expressed by general-based models (EBMs). Among them, representative models including restricted Boltzmann machines (RBMs), deep belief networks (DBNs) and deep Boltzmann machines (DBMs) have been widely adopted. EBM is a useful tool for producing a generative model. Generative modeling is the task of observing data, such as images or text, and learning to model the underlying data distribution. Accomplishing this task leads models to understand high level features in data and synthesize examples that look like real data. Generative models have many applications in natural language, robotics, and computer vision. Energy-based models are able to generate qualitatively and quantitatively high-quality images, especially when running the refinement process for a longer period at test time. EBM may also be used for producing a discriminative model by training a neural network in a supervised machine learning.

EBMs represent probability distributions over data by assigning an unnormalized probability scalar or “energy” to each input data point. Formally, a distribution defined by an EBM may be expressed as:

p(w; θ)=\tilde{p}(w; θ)/ [symbol] (θ)=e^{-ε(w; θ)}/ [symbol] (θ) Eq. (1)

where ε(w; θ) is the associated energy function parameterized by learnable parameters θ, \tilde{p}(w; θ) is the unnormalized density, and [symbol] (θ)=∫e^{ε(w; θ)}dw is the partition function.

In one aspect, in case that w is fully visible and continuous, a Fisher Divergence method may be employed to learn the EBM defined by equation (1). The fisher divergence between the model distribution p(w; θ) and the true data distribution p_{D}(w) is defined as:

$${𝒟}_{F} ( {p}_{D} ( w ) ∥ p ( w ; θ ) ) \frac{1}{2} {𝔼}_{{p}_{D} ( w )} [ {‖ {∇}_{w} log p ( w ; θ ) - {∇}_{w} log {p}_{D} ( w ) ‖}_{2}^{2} ] \qquad Eq . ( 2 )$$

where ∇_{w} log p(w; θ) and ∇_{w} log p_{D}(w) are the model score function and data score function, respectively. The model score function does not depend on the value of the partition function [symbol] (θ), since:

∇_{w} log p(w; θ)=∇_{w} log \tilde{p}(w; θ)−∇_{w} log [symbol] (θ)=∇_{w} log \tilde{p}(w; θ),

which makes the Fisher divergence method suitable for learning EBMs.

In another aspect, since the true data distribution p_{D}(w) is generally unknown, an equivalent method named score matching (SM) is provided as follows to get rid of the unknown ∇_{w} log p_{D}(w):

$${𝒥}_{S M} ( θ ) {𝔼}_{{p}_{D} ( w )} [ \frac{1}{2} {‖ {∇}_{w} log \tilde{p} ( w ; θ ) ‖}_{2}^{2} + t r ( {∇}_{w}^{2} log \tilde{p} ( w ; θ ) ) ] ≡ {𝒟}_{F} ( {p}_{D} ( w ) \vert \vert p ( w ; θ ) ) \qquad Eq . ( 3 )$$

where ∇_{w}² log \tilde{p}(w; θ) is the Hessian matrix, tr(●) is trace of a given matrix, and ≡ means equivalence in parameter optimization. However, a straightforward application of SM is inefficient, as the computation of tr(∇_{w}² log \tilde{p}(w; θ)) is time-consuming on high-dimensional data.

In another aspect, in order to solve the above problem in SM method, a sliced score matching (SSM) method is provided as follows:

$${𝒥}_{S S M} ( θ ) \frac{1}{2} {𝔼}_{{p}_{D} ( w )} [ {‖ {∇}_{w} log \tilde{p} ( w ; θ ) ‖}_{2}^{2} ] + {𝔼}_{{p}_{D} ( w )} {𝔼}_{p ( u )} [ {u}^{T} {∇}_{w}^{2} log \tilde{p} ( w ; θ ) u ] \qquad Eq . ( 4 )$$

where u is a random variable that is independent of w, and p(u) satisfies certain mild conditions to ensure that SSM is consistent with SM. Instead of calculating the trace of the Hessian matrix in SM method, SSM computes the product of the Hessian matrix and a vector, which can be efficiently implemented by taking two normal back-propagation processes.

In another aspect, another fast variant of SM method named denoising score matching (DSM) is also provided as follows:

[symbol]

_{DSM}(θ) [symbol] [symbol] ₚ_{_{D}}_{(w)p}_{_{σ}}_{(\tilde{w}|w)}∥∇_{\tilde{w}} log \tilde{p}(\tilde{w}; θ)−∇_{\tilde{w}} log p_{σ}(\tilde{w}|w)∥₂²≡ [symbol] _{F}(p_{σ}(\tilde{w})∥p(\tilde{w}; θ)) Eq. (5)

where \tilde{w} is the data perturbed by a noise disitribution p_{σ}(\tilde{w}|w) with a hyperparameter σ and p_{σ}(\tilde{w})=∫p_{D}(w)p_{σ}(\tilde{w}|w)dw . In one embodiment, the noise (or perturbation) distribution may be the Gaussian distribution, such that p_{σ}(\tilde{w}|w)=N(\tilde{w}|w, σ²l).

In further another aspect, a variant of DSM method named multiscale denoising score matching (MDSM) is provided as follows to leverage different levels of noise to train EBMs on high-dimensional data:

[symbol]

_{MDSM}(θ) [symbol] [symbol] ₚ_{_{D}}_{(w)p(σ)p}_{_{σ}}_{(\tilde{w}|w)}∥∇_{\tilde{w}} log \tilde{p}(\tilde{w}; θ)−∇_{\tilde{w}} log p_{σ}_{₀} (\tilde{w}; w)∥₂² Eq. (6)

where p(σ) is a prior distribution over the noise levels and σ₀ is a fixed noise level.

Although an SM-based objective of minimizing one of the equations (2)-(6) as described above may be employed by those ordinary skilled person in the art for learning EBMs with fully visible and continuous variables, it becomes more and more difficult to build accurate and high performance energy models based on the existing methods due to the complicated characteristics of high nonlinearity, high dimension and strong coupling of real data. The present disclosure extends the above SM-based method to learn EBMs with latent variables (i.e., EBLVMs), which are applicable to the complicated characteristics of real data in various specific actual applications.

Formally, an EBLVM defines a probability distribution over a set of visible variables v and a set of latent variables h as follows:

p(v, h; θ)=\tilde{p}(v, h;θ)/ [symbol] (θ)=e^{-ε(v, h; θ)}/ [symbol] (θ) Eq. (7)

where ε(v, h; θ) is the associated energy function with learnable parameters θ, \tilde{p}(v, h; θ) is the unnormalized density, and [symbol] (θ)=∫e^{-ε(v, h; θ)}dvdh is the partition function. Generally, the EBLVM defines a joint probability distribution of the visible variables v and latent variables h with the learnable parameters θ. In other words, the EBLVM to be learned is defined by the parameters θ, a set of visible variables v and a set of latent variables h.

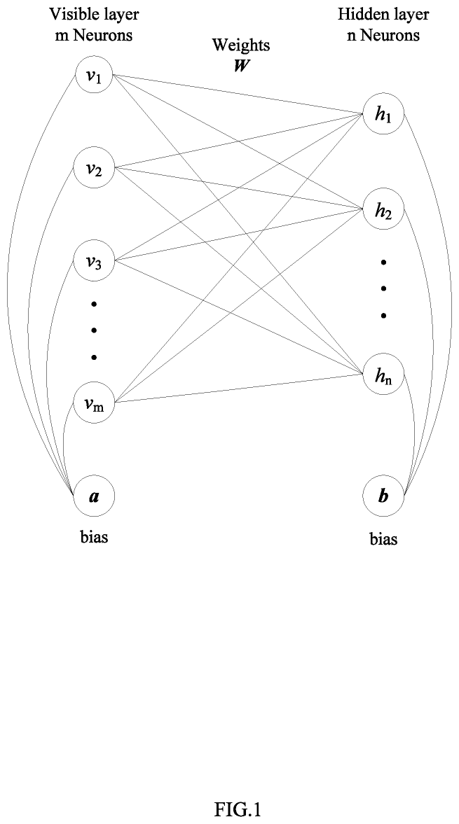

FIG. 1 illustrates an exemplary structure of a restricted Boltzmann machine based on an energy-based latent variable model according to one embodiment of the present disclosure. A restricted Boltzmann machine (RBM) is a representative neural network based on EBLVM. RBMs are widely used for dimensionality reduction, feature extraction, and collaborative filtering. The feature extraction by RBM is completely unsupervised and does not require any hand-engineered criteria. RBM and its variants may be used for feature extraction from images, text data, sound data, and others.

As shown in FIG. 1, a RBM is a stochastic neural network with a visible layer and a hidden layer. Each neural unit of the visible layer has an undirected connection with each neural unit of the hidden layer, with weights (W) associated with them. Each neural unit of the visible and hidden layer is also connected with their respective bias units (a and b). RBMs do not have connections among the visible units and similarly in hidden units also. This restriction on connection makes it restricted Boltzmann machines. The number (m) of neural units in the visible layer depends on the dimension of visible variables (v), and the number (n) of neural units in the hidden layer depends on the dimension of latent variables (h). The state of a neuron unit in a hidden layer is stochastically updated based on the state of the visible layer and vice versa for the visible unit.

In the example of RBM, the energy function of EBLVM in equation (7) may be expressed as ε(v, h; θ)=−a^{T}v−b^{T}h−h^{T}Wv, where a and b are bias of the visible units and hidden units respectively, the parameter W is weights of the connection between visible and hidden layer units, and the learnable parameters θ refer to the set of network parameters (a, b, W) of the RBM.

In another embodiment, a neural network based on EBLVM may a Gaussian restricted Boltzmann machine (GRBM). The energy function of GRBM may be expressed as

$$ℰ ( v , h ; θ ) = \frac{1}{2 {σ}^{2}} {‖ v - b ‖}^{2} - {c}^{T} h - \frac{1}{σ} {v}^{T} Wh ,$$

where the learnable network parameters θ are (σ, W, b, c). In further embodiments, some deep neural networks may also be trained based on EBLVMs according to the present disclosure, such as deep belief networks (DBNs), convolutional deep belief networks (CDBNs), and deep Boltzmann machines (DBMs), etc. and Gaussian restricted Boltzmann machines (GRBMs). For example, as compared with the RBM described above, DBMs may have two or more hidden layers. A deep EBLVM with energy function ε(v, h; θ)=g₃(g₂(g₁(v; θ₁), h); θ₂) is disclosed in the present disclosure, where the learnable network parameters θ=(θ₁, θ₂), g₁(●) is a neural network that outputs a feature sharing the same dimension with h, g₂(●, ●) is an additive coupling layer to make the features and the latent variables strongly coupled, and g₃(●) is a small neural network that outputs a scalar.

Generally, the purpose for training a neural network based on an EBLVM with an energy function of ε(v, h; θ) is to learn the network parameters θ which defines the joint probability distribution of visible variables v and latent variables h. A skilled person in the art can implement the neural network based on the learned network parameters by general processing units/processors, dedicated processing units/processors, or even application specific integrated circuits. In one embodiment, the network parameters may be implemented as the parameters in a software module executable by a general or dedicated processor. In another embodiment, the network parameters may be implemented as the structure of a dedicated processor or the weights between each logic unit of an application specific integrated circuit. The present disclosure is not limited to specific techniques for implementing neural networks.

In order to train a neural network based on an EBLVM with an energy function of ε(v, h; θ), the network parameters θ need to be optimized based on an objective of minimizing a divergence between the model marginal probability distribution p(v; θ) and the true data distribution p_{D}(v). In one embodiment, the divergence may be the Fisher divergence between the model marginal probability distribution p(v; θ) and the true data distribution p_{D}(v) as in equation (2) or (3) described above based on EBMs with fully visible variables. In another embodiment, the divergence may be the Fisher divergence between the model marginal probability distribution p(v; θ) and the perturbed one p_{σ}(\tilde{v})=∫p_{D}(v)p_{σ}(\tilde{v}|v)dv as in equation (5) of DSM method described above. In different embodiments, the true data distribution p_{D}(v), the perturbed one p_{σ}(\tilde{v}), as well as the other variants, may be uniformly expressed as q(v). Generally, an equivalent SM objective for training EBMs with latent variables may be expressed in the following form:

[symbol]

(θ)= [symbol] _{q(v, ϵ)} [symbol] ∇ᵥ log p(v; θ), ϵ, v) Eq. (8)

where [symbol] is a function that depends on one of the SM objectives in equations (3)-(6), ϵ is used to represent additional random noise used in SSM or DSM, and q(v, ϵ) denotes the joint distribution of v and ϵ. The same challenge for all SM objectives for training neural networks based on EBLVMs is that the marginal score function ∇ᵥ log p(v; θ) is intractable, since both the marginal probability distribution p(v; θ) and the posterior probability distribution p(h|v; θ) are always intractable.

Accordingly, a bi-level score matching (BiSM) method for training neural networks based on EBLVMs is provided in the present disclosure. The BiSM method solves the problem of intractable marginal probability distribution and posterior probability distribution by a bi-level optimization approach. The lower-level optimizes a variational posterior distribution of the latent variables to approximate the true posterior distribution of the EBLVM, and the higher-level optimizes the neural network parameters based on a modified SM objective as a function of the variational posterior distribution.

Firstly, considering that the marginal score function can be rewritten as:

$${∇}_{v} log p ( v ; θ ) = {∇}_{v} log \frac{\tilde{p} ( v , h ; θ )}{p ( h \vert v ; θ )} - {∇}_{v} log 𝒵 ( θ ) = {∇}_{v} log \frac{\tilde{p} ( v , h ; θ )}{p ( h \vert v ; θ )}$$

we use a variational posterior probability distribution q(h|v; φ) to approximate the true posterior probability distribution p(h|v; θ), to obtain an approximation of the marginal score function based on

$${∇}_{v} log \frac{\tilde{p} ( v , h ; θ )}{q ( h \vert v ; φ )} .$$

Thus, in me lower-level optimization, the objective is to optimize the set of parameters φ of the variational posterior probability distribution q(h|v; φ), to obtain a set of parameters φ*(θ). In one embodiment, φ*(θ) may be defined as follows:

$${φ}^{*} ( θ ) = {argmin}_{φ ∈ ϕ} 𝒢 ( θ , φ ) , with 𝒢 ( θ , φ ) = {𝔼}_{q ( v , ϵ )} 𝒟 ( q ( h \vert v ; φ ) \vert \vert p ( h \vert v ; θ ) ) \qquad Eq . ( 9 )$$

where ϕ is a hypothesis space of the variational posterior probability distribution, q(v, ϵ) denotes the joint distribution of v and ϵ as in equation (8), and [symbol] is a certain divergence depending on a specific embodiment. In the present disclosure, φ* is defined as a function of θ to explicitly present the dependency there between.

Secondly, in the higher-level optimization, the network parameters θ are optimized based on a score matching objective by using the ratio of the model distribution over a variational posterior to approximate the model marginal distribution. In one embodiment, the general SM objective in equation (8) may be modified as:

$${θ}^{*} = arg {min}_{θ ∈ Θ} {𝒥}_{B i} ( θ , {φ}^{*} ( θ ) ) , {𝒥}_{B i} ( θ , φ ) = {𝔼}_{q ( v , ϵ )} {𝔼}_{q ( h \vert v ; φ )} ℱ ( {∇}_{v} log \frac{\tilde{p} ( v , h ; θ )}{q ( h \vert v ; φ )} , ϵ , v ) \qquad Eq . ( 10 )$$

where Θ is the hypothesis space of the EBLVM, φ*(θ) is the optimized parameters of the variation posterior probability distribution, and [symbol] is a certain SM based objective function depending on a specific embodiment. It can be proved that, under the bi-level optimization in the present disclosure, a score function of the original SM objective in equation (8) may be equal to or approximately equal to a score function of the modified SM objective in equation (10), i.e.,

∇_{θ} [symbol] (θ)=∇_{θ} [symbol] _{Bi}(θ, φ*(θ)).

The Bi-level Score Matching (BiSM) method described in the present disclosure are applicable to training a neural network based on EBLVMs, even if the neural network is highly nonlinear and nonstructural (such as, DNNs), and the training data has complicated characteristics of high nonlinearity, high dimension and strong coupling (such as, image data), in which cases most existing models and training methods are not applicable. Meanwhile, the BiSM method may also provide comparable performance to the existing techniques (such as, contrastive divergence and SM-based methods) when they are applicable. Detailed description on the BiSM method is provided below in connection with several specific embodiments and accompanying drawings. The variants of the specific embodiments are apparent for those skilled in the art in view of the present disclosure. The scope of the present disclosure is not limited to these specific embodiments described herein.

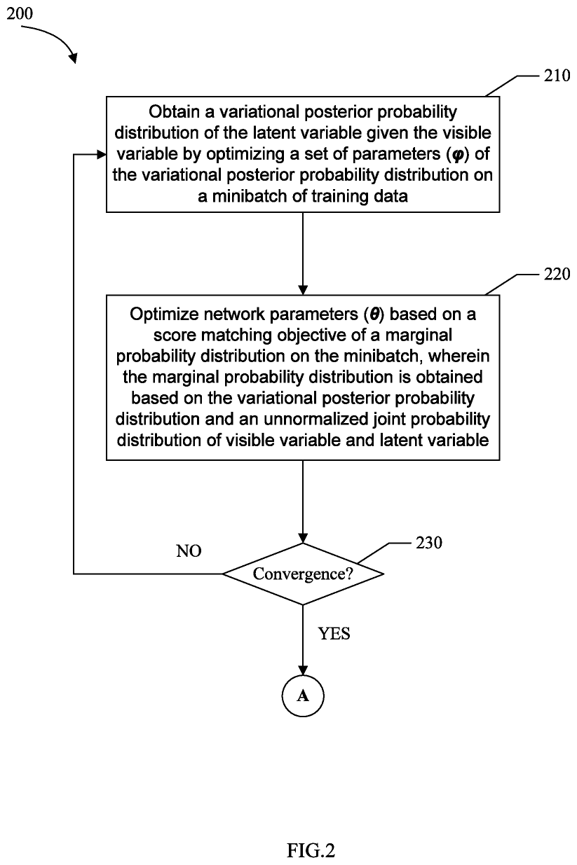

FIG. 2 illustrates a general flowchart of a method 200 for training a neural network based on an EBLVM according to one embodiment of the present disclosure. Method 200 may be used for training a neural network based on an energy-based model with a batch of training data. The neural network to be trained may be implemented by a general processor, an application specific processor, such as a neural network processor, or even an application specific integrated circuit in which each neuron in the neural network may be implemented by one or more specific logic units. In other words, training a neural network by method 200 also means designing or configuring the structure and/or parameters of the specific processors or logic units to some extent.

In some embodiments, the energy-based model may be an energy-based latent variable model defined by a set of network parameters θ, a visible variable v, and a latent variable h. An energy function of the energy-based model may be expressed as ε(v, h; θ), and a joint probability distribution of the model may be expressed as p(v, h; θ). The detailed information of the network parameters θ depends on the structure of the neural network. For example, the neural network may be RBM, and the network parameters may include weights W between each neuron in a visible layer and each neuron in a hidden layer and biases (a, b), each of W, a and b may be a vector. For another example, the neural network may be a deep neural network, such as, deep belief networks (DBNs), convolutional deep belief networks (CDBNs), and deep Boltzmann machines (DBMs). For a deep EBLVM with energy function ε(v, h; θ)=g₃(g₂(g₁(v; θ₁), h); θ₂) , the network parameters θ=(θ₁, θ₂), where θ₁ is the sub network parameters of a neural network g₁(●), and θ₂ is the sub network parameters of a neural network g₃(●). The neural network in the present disclosure may be any other neural network that may be expressed based on EBLVMs. The visible variable v may be the variable that can be observed directly from the training data. The visible variable v may be high-dimensional data expressed by a vector. The latent variable h may be a variable that cannot be observed directly and may affect the output response to visible variable. The training data may be image data, video data, audio data, and any other type of data in a specific application scenario.

At step 210, the method 200 may comprise obtaining a variational posterior probability distribution of the latent variable given the visible variable by optimizing a set of parameters (φ) of the variational posterior probability distribution on a minibatch of training data. The variational posterior probability distribution is provided to approximate a true posterior probability distribution of the latent variable given the visible variable, since the true posterior probability distribution as well as the marginal probability distribution are generally intractable. The true posterior probability distribution refers to the true posterior probability distribution of the energy-based model, and is relevant to the network parameters (θ) of the model. The parameters (φ) of the variational posterior probability distribution may belong to a hypothesis space of the variational posterior probability distribution, and the hypothesis space may depend on the chosen or assumed probability distribution. In one embodiment, the variational posterior probability distribution may be a Bernoulli distribution parameterized by a fully connected layer with sigmoid activation. In another embodiment, the variational posterior probability distribution may be a Gaussian distribution parameterized by a convolutional neural network, such as a 2-layer convolutional neural network, a 3-layer convolutional neural network, or a 4-layer convolutional neural network.

The optimization of the parameters (φ) of the variational posterior probability distribution may be performed according to equation (9). In order to learn general EBLVMs with intractable posteriors, the lower-level optimization of step 210 can only access the unnormalized model joint distribution \tilde{p}(v, h; θ) and the variational posterior distribution q(h|v; φ) in calculation, while the true model posterior distribution p(h|v; θ) in equation (9) is intractable.

In one embodiment, a Kullback-Leibler (KL) divergence may be adopted, and an equivalent form for optimizing the parameters (φ) may be obtained as below, from which an unknown constant is subtracted:

$${𝒟}_{K L} ( q ( h \vert v ; φ ) \vert \vert p ( h \vert v ; θ ) ) ≡ {𝔼}_{q ( h \vert v ; φ )} log \frac{q ( h \vert v ; φ )}{\tilde{p} ( v , h ; θ )} \qquad Eq . ( 11 )$$

Therefore, equation (11) is sufficient for training the parameters (φ), but not suitable for evaluating the inference accuracy.

In another embodiment, a Fisher divergence for variational inference may be adopted, and can be directly calculated by:

$${𝒟}_{F} ( q ( h \vert v ; φ ) \vert \vert p ( h \vert v ; θ ) ) = \frac{1}{2} {𝔼}_{q ( h \vert v ; φ )} [ {‖ {∇}_{h} log q ( h \vert v ; φ ) - {∇}_{h} log \tilde{p} ( v , h ; θ ) ‖}_{2}^{2} ] \qquad Eq . ( 12 )$$

Compared with the KL divergence in equation (11), the Fisher divergence in equation (12) can be used for both training and evaluation, but cannot deal with discrete latent variable h in which case ∇ₕ is not well defined. In principle, any other divergence that does not necessarily know p(v; θ) or p(h|v; θ) can be used in step 210. The specific divergence in equation (9) may be selected according to the specific scenario.

At step 220, the method 200 may comprise optimizing network parameters (θ) based on a score matching objective of a marginal probability distribution on the same minibatch of training data as in step 210. The marginal probability distribution is obtained based on the variational posterior probability distribution and an unnormalized joint probability distribution of the visible variable and the latent variable. The higher-level optimization for network parameters (θ) may be performed based on the score matching objective in equation (10). The score matching objective may be based at least in part on one of sliced score matching (SSM), denoising score matching (DSM), or multiscale denoising score matching (MDSM) as described above. The marginal probability distribution may be an approximation of the true model marginal probability distribution, and is calculated based on the variational posterior probability distribution obtained in step 210 and an unnormalized joint probability distribution derived from the energy function of the model.

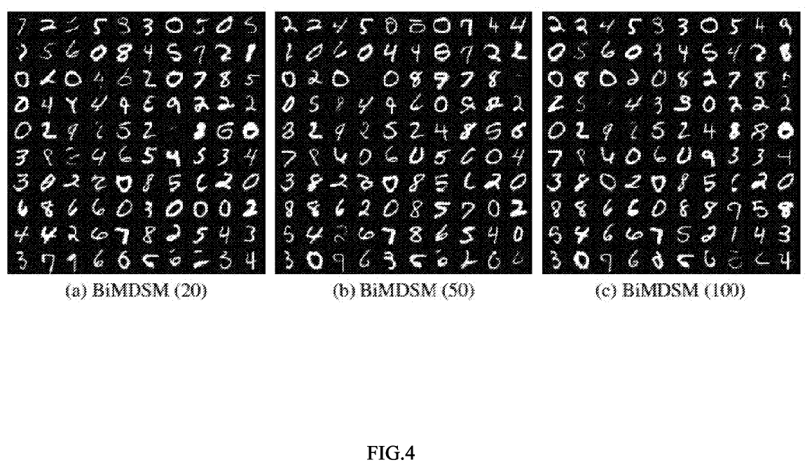

The method 200 may further comprise repeating the step 210 of obtaining a variational posterior probability distribution and the step 220 of optimizing network parameters (θ) on different minibatches of the training data, till a convergence condition is satisfied. For example, as shown in step 230, it is determined whether convergence of the score matching objective is satisfied. If no, method 200 will proceed back to step 210 and obtain a variational posterior probability distribution of the latent variable given the visible variable by optimizing a set of parameters (φ) of the variational posterior probability distribution on another minibatch of the training data. Then, method 200 will proceed to step 220 and further optimize the network parameters (θ) on said another minibatch of the training data. In one embodiment, the convergence condition is that the score matching objective reaches a certain threshold for a certain number of times. In another embodiment, the convergence condition is that the steps of 210 and 220 have been repeated for a predetermined number of times. The predetermined number may depend on performance requirement, volume of training data, time efficiency. In a particular case, the predetermined number of repeating times may be zero. If the convergence condition is satisfied, method 200 will proceed to node A as shown in FIG. 2, where the trained neural network may be used for generation, inference, anomaly detection, etc. based on a specific application. The specific applications of neural network trained according to a method of the present disclosure will be described in detail in connection with FIGS. 4-7 below.

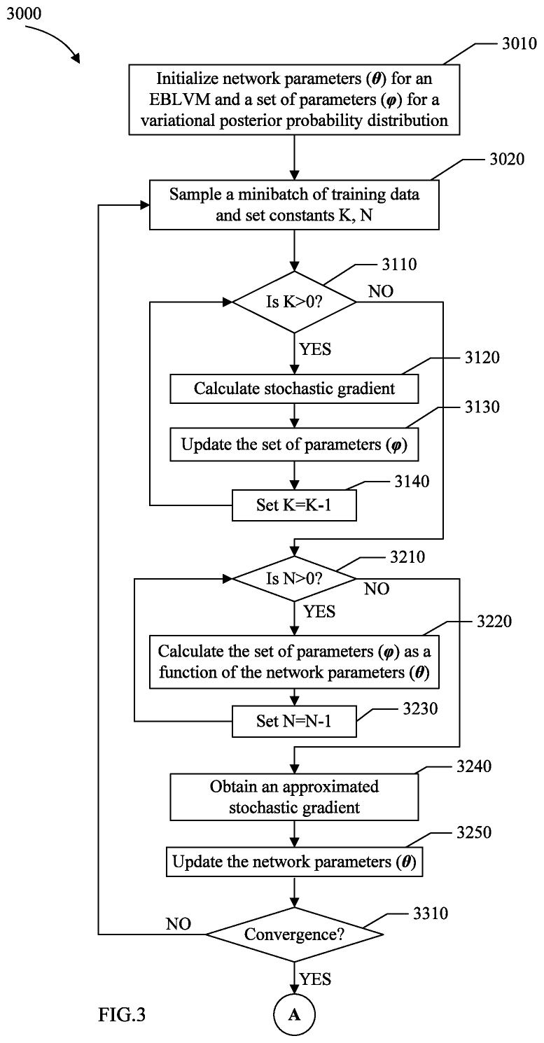

FIG. 3 illustrates a detailed flowchart of a method 3000 for training a neural network based on an energy-based model with a batch of training data according to one embodiment of the present disclosure. The energy-based model may be an EBLVM defined by a set of network parameters (θ), a visible variable and a latent variable. The specific embodiment of method 3000 provides more details as compared to the embodiment of method 200. The description on method 3000 below may also be applied or combined to the method 200. For example, the steps 3110-3140 of method 3000 as shown in FIG. 3 may correspond to the step 210 of method 200, and the steps 3210-3250 of method 3000 may correspond to the step 220 of method 200.

At step 3010, before starting a method for training a neural network based on an EBLVM according to the present disclosure, network parameters (θ) for the neural network based on the EBLVM and a set of parameters (φ) of a variational posterior probability distribution for approximating the true posterior probability distribution of the EBLVM are initialized. The initialization may be in a random way, based on given values depending on specific scenarios, or based on fixed initial values. The detailed information of the network parameters (θ) may depend on the structure of the neural network. The parameters (φ) of the variational posterior probability distribution may depend on the chosen or assumed specific probability distribution.

At step 3020, a minibatch of training data is sampled from a full batch of training data for one iteration of bi-level optimization, and the constants K and N respectively used in the lower-level optimization and the higher-level optimization are set, where K and N are integers greater than or equal to zero, and may be set based on a system performance, time efficiency, etc. Here, one iteration of bi-level optimization refers to a cycle from step 3020 to step 3310. In one embodiment, the full batch of training data may be divided into a plurality of minibatches, and one minibatch may be sampled from the plurality of minibatches sequentially each time. In another embodiment, the minibatch may be sampled randomly from the full batch.

Next, a preferred solution for performing the BiSM method of the present disclosure by updating the network parameters (θ) and the parameters (φ) of a variational posterior probability distribution using stochastic gradient descent is described. The parameters (φ) of the variational posterior probability distribution are updated in steps 3110-3140, and the network parameters (θ) are updated in steps 3210-3250.

At step 3110, it is determined whether K is greater than 0. If yes, the method 3000 proceeds to step 3120, where a stochastic gradient of a divergence objective between the variational posterior probability distribution and the true posterior probability distribution of the model is calculated under given network parameters (θ). The given network parameters (θ) may be the network parameters (θ) initialized at step 3010 in the first iteration of the bi-level optimization, or may be the network parameters (θ) updated in step 3250 in a previous iteration of the bi-level optimization. The divergence between the variational posterior probability distribution and the true posterior probability distribution may be based on equation (9). Then, the stochastic gradient of the divergence objective may be calculated as

$$\frac{\partial \hat{𝒢} ( θ , φ )}{\partial φ} ,$$

where [symbol] (θ, φ) denotes the function of [symbol] (θ, φ) in equation (10) evaluated on the sampled minibatch.

At step 3130, the set of parameters (φ) may be updated based on the calculated stochastic gradient by starting from the initialized or previously updated set of parameters (φ). For example, the set of parameters (φ) may be updated according to:

$$φ ← φ - α \frac{\partial \hat{𝒢} ( θ , φ )}{\partial φ} \qquad Eq . ( 13 )$$

where α is a learning rate. In one embodiment, α may be based on a prefixed learning rate scheme. In another embodiment, α may be dynamically adjusted during the optimizing procedure.

At step 3140, K is set to be K−1. Then, method 3000 proceeds back to step 3110, where whether K>0 is determined. In yes, the steps 3120-3140 will be repeated again on the same minibatch, till K is below zero. In other words, method 3000 comprises repeating the steps of 3120 and 3130, i.e. updating the set of parameters (φ), for a number of K times. The optimized or updated set of parameters (φ) through steps 3110 to 3140 may be denoted as φ⁰. In a special case of initially setting K=0, φ⁰ may be the set of parameters (φ) initialized in step 3010.

To update the network parameters (θ), it is challenging to calculate the stochastic gradient of the SM objective [symbol] _{Bi}(θ, φ*(θ)) in equation (10) due to the item of (φ*(θ). Accordingly, \hat{φ}^{N}(θ) is calculated to approximate (φ*(θ) on the sampled minibatch through steps 3210 to 3230. In one embodiment of the present disclosure, the \hat{φ}^{N}(θ) is calculated recursively starting from φ⁰ by:

$${{\hat{φ}}^{1} ( θ ) = {φ}^{0} - α \frac{\partial \hat{𝒢} ( θ , φ )}{\partial φ} \vert}_{φ = {φ}^{0}} , and \qquad Eq . ( 14 )$$

$${{\hat{φ}}^{n} ( θ ) = {\hat{φ}}^{n - 1} ( θ ) - α \frac{\partial \hat{𝒢} ( θ , φ )}{\partial φ} \vert}_{φ = {\hat{φ}}^{n - 1} ( θ )} , …$$

for n=2, . . . , N.

As shown by steps 3210 to 3230, method 3000 comprises calculating the set of parameters (φ) as a function of the network parameters (θ) recursively for a number of N times by starting from a randomly initialized or previously updated set of parameters (φ), wherein N is an integer equal to or greater than zero. In a special case of initially setting N=0, the \hat{φ}^{N}(θ) is calculated as φ⁰.

At step 3240, an approximated stochastic gradient of the score matching objective is obtained based on the calculated \hat{φ}^{N}(θ). In one embodiment, the stochastic gradient

$$\frac{\partial {\hat{𝒥}}_{Bi} ( θ , \hat{φ} ( θ ) )}{\partial θ}$$

of the SM objective may be approximated by the gradient of a surrogate loss [symbol] _{bi},(θ, \hat{φ}^{N}(θ)) according to:

$${{\frac{\partial {\hat{𝒥}}_{Bi} ( θ , {\hat{φ}}^{N} ( θ ) )}{\partial θ} = \frac{\partial {\hat{𝒥}}_{Bi} ( θ , φ )}{\partial θ} \vert}_{φ = {\hat{φ}}^{N} ( θ )} + \frac{\partial {\hat{𝒥}}_{Bi} ( θ , φ )}{\partial φ} \vert}_{φ = {\hat{φ}}^{N} ( θ )} \frac{\partial {\hat{φ}}^{N} ( θ )}{\partial θ} \qquad Eq . ( 15 )$$

At step 3250, the network parameters (θ) is updating based on the approximated stochastic gradient. In one embodiment, method 3000 may comprise updating the network parameters (θ) of the neural network being trained according to:

$$θ ← θ - β \frac{\partial {\hat{𝒥}}_{Bi} ( θ , {\hat{φ}}^{N} ( θ ) )}{\partial θ} \qquad Eq . ( 16 )$$

where β is a learning rate. In one embodiment, α may be based on a prefixed learning rate scheme. In another embodiment, α may be dynamically adjusted during the optimizing procedure. In case that the neural network is implemented by a general processor, updating the network parameters (θ) may comprise update the parameters in a software module executable by the general. In case that the neural network is implemented by an application specific integrated circuit, updating the network parameters (θ) may comprise update the operation or the weights between each logic unit of the application specific integrated circuit.

At step 3310, it is determined whether a convergence condition is satisfied. If no, method 3000 will proceed back to step 3020, where another minibatch of training data is sampled for a new iteration of bi-level optimization, and the constants K and N may be reset to the same values as or different values from the values set in the previous iteration. Then, method 3000 may proceed to repeat the lower-level optimization in steps 3110-3140 and higher-level optimization in steps 3210-3250. In one embodiment, the convergence condition is that the score matching objective reaches a certain threshold for a certain number of times. In another embodiment, the convergence condition is that the iterations of bi-level optimization have been performed for a predetermined number of times. If the convergence condition is determined to be satisfied, method 3000 will proceed to node A as shown in FIG. 3, where the trained neural network may be used for generation, inference, anomaly detection, etc. based on a specific application as described below.

The bi-level score matching method according to the present disclosure is applicable to train a neural network based on complex EBLVMs with intractable posterior distribution in a purely unsupervised learning setting for generating natural images. FIG. 4 shows natural images of hand-written digits generated by a generative neural network trained according to one embodiment of the present disclosure. In such an example, the generative neural network may be trained based on EBLVMs according to the method 200 and/or method 3000 of the present disclosure as described above in connection with FIGS. 2-3, under the learning setting as follows.

To train a hand-written digit generative neural network, the Modified National Institute of Standards and Technology (MNIST) database may be used as the training data. MNIST is a large database of black and white handwritten digit images with size 28×28 and grayscale levels that is commonly used for training various image processing systems. In one embodiment, a batch of training data may comprise 60,000 digit image data samples split from the MNIST database, each having 28×28 grayscale level values.

The generative neural network may be based on a deep EBLVM with energy function ε(v, h; θ)=g₃(g₂(g₁(v; θ₁), h); θ₂), where the learnable network parameters θ=(θ₁, θ₂), g₁(●) is a neural network that outputs a feature sharing the same dimension with h, g₂(●, ●) is an additive coupling layer to make the features and the latent variables strongly coupled, and g₃(●) is a small neural network that outputs a scalar. In this example, g₁(●) is a 12-layer ResNet, and g₃(●) is a fully connected layer with ELU activation function and used the square of 2-norm to output a scalar. The visible variable v may be the grayscale levels of each pixel in the 28×28 images. The dimension of latent variable h may be set as 20, 50 and 100, respectively corresponding to the images (a), (b) and (c) in FIG. 4.

In this example, the variational posterior probability distribution q(h|v; φ) for approximating the true posterior probability distribution of the model is parameterized by a 3-layer convolutional neural network as Gaussian distribution. K and N as shown in step 3020 of FIG. 3 may be set respectively to 5 and 0 for time and memory efficiency. The learning rates α and β in equations (13) and (16) may be set to 10⁻⁴. The MDSM function in equation (6) is used as the SM based objective function in equation (9), that is, the BiSM method in this example may also be called as BiMDSM.

Generally, under the learning setting described above, a hand-written digit image generative neural network may be trained based on a Deep EBLVM, e.g., ε(v, h; θ)=g₃(g₂(g₁(v; θ₁), h); θ₂), with the batch of digit image data samples by: obtaining a variational posterior probability distribution of the latent variable h given the visible variable v by optimizing a set of parameters (φ) of the variational posterior probability distribution on a minibatch of digit image data sampled from the batch of image data, wherein the variational posterior probability distribution is provided to approximate a true posterior probability distribution of the latent variable h given the visible variable v wherein the true posterior probability distribution is relevant to the network parameters (θ); optimizing network parameters (θ) based on a BiMDSM objective of a marginal probability distribution on the minibatch of digit image data, wherein the marginal probability distribution is obtained based on the variational posterior probability distribution and an unnormalized joint probability distribution of the visible variable v and the latent variable h; and repeating the steps of obtaining a variational posterior probability distribution and optimizing network parameters (θ) on different minibatches of digit image data, till convergence condition satisfied, e.g., for 100,000 times of iterations.

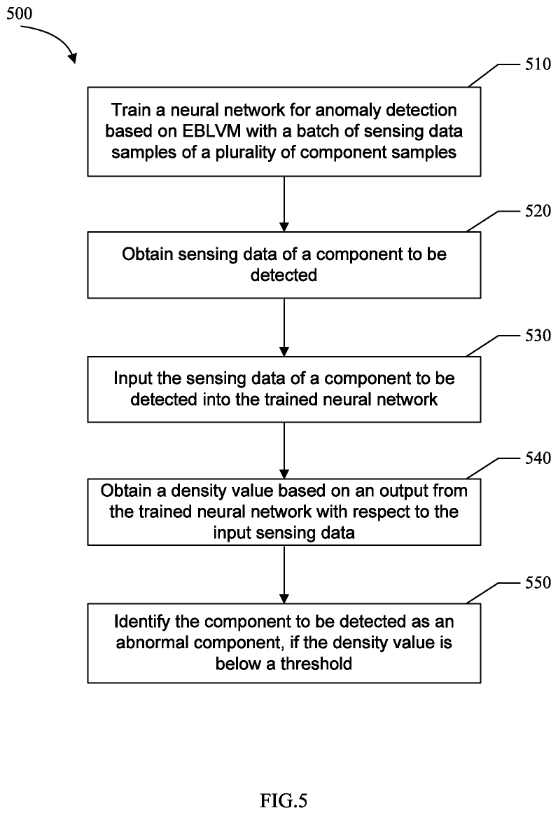

The bi-level score matching method according to the present disclosure is applicable to train a neural network in an unsupervised way, and the thus-trained neural network can be used for anomaly detection. Anomaly detection may be used for identifying abnormal or defect ones from product components on an assembly line. On the real assembly line, the number of defect or abnormal components are much fewer than that of good or normal components. Anomaly detection has great importance to detect defect components, so as to ensure the product quality. FIGS. 5-7 illustrate different embodiments of performing anomaly detection by training a neural network according to the methods of the present disclosure.

FIG. 5 illustrates a flowchart of method 500 of training a neural network for anomaly detection according to one embodiment of the present disclosure. In step 510, a neural network for anomaly detection is trained based on EBLVM with a batch of training data comprising sensing data samples of a plurality of component samples. For example, the component may be parts of products for assembling motor vehicle. The sensing data may be image data, sound data, or any other data captured by a camera, a microphone, or a sensor, such as, IR sensor, or ultrasonic sensor, etc. In one embodiment, the batch of training data may comprise a plurality of ultrasonic sensing data detected by an ultrasonic sensor on a plurality of component samples.

The training in step 510 may be performed according to the method 200 of FIG. 2 or method 3000 of FIG. 3. Generally, an anomaly detection neural network may be trained based on an EBLVM defined by a set of network parameters (θ), a visible variable v and a latent variable h with a batch of sensing data samples by: obtaining a variational posterior probability distribution of the latent variable h given the visible variable v by optimizing a set of parameters (v) of the variational posterior probability distribution on a minibatch of sensing data sampled from the batch of sensing data samples, wherein the variational posterior probability distribution is provided to approximate a true posterior probability distribution of the latent variable h given the visible variable v wherein the true posterior probability distribution is relevant to the network parameters (θ); optimizing network parameters (θ) based on a certain BiSM objective of a marginal probability distribution on the minibatch of sensing data, wherein the marginal probability distribution is obtained based on the variational posterior probability distribution and an unnormalized joint probability distribution of the visible variable v and the latent variable h; and repeating the steps of obtaining a variational posterior probability distribution and optimizing network parameters (θ) on different minibatches of the sensing data, till convergence condition satisfied.

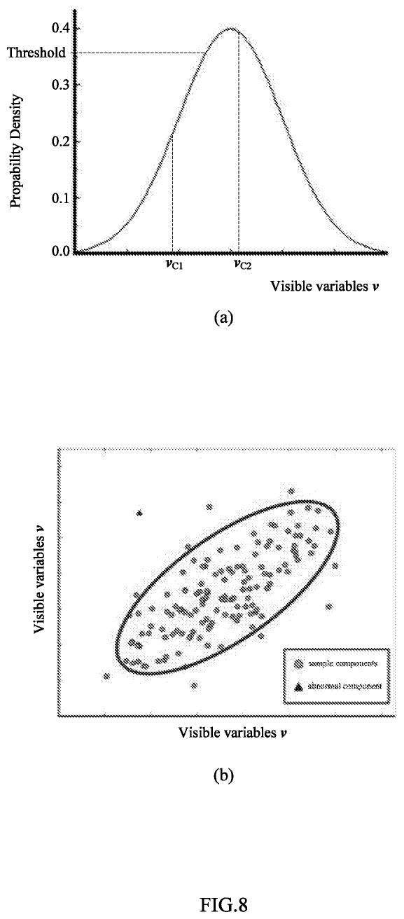

After training the anomaly detection neural network, in step 520, the sensing data of a component to be detected is obtained through a corresponding sensor. In step 530, the obtained sensing data is input into the trained neural network. In step 540, a probability density value corresponding to the component to be detected is obtained based on an output of the trained neural network with respect to the input sensing data. In one embodiment, a probability density function may be obtained based on a probability distribution function of the model of the trained neural network, and the probability distribution function is based on the energy function of the model, as express in equation (7). In step 550, the obtained density value of the sensing data is compared with a predetermined threshold, and if the density value is below the threshold, the component to be detected is identified as an abnormal component. For example, as shown in FIG. 8, the density value of component C1 with visible variable v_{C1} is below the threshold and may be identified as an abnormal component, while the density value of component C2 with visible variable v_{C2} is above the threshold and may be identified as a normal component.

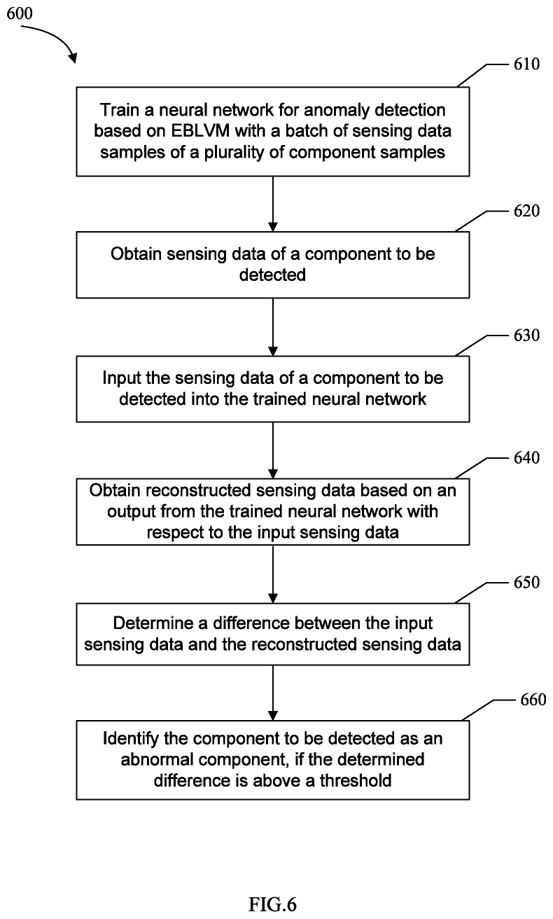

FIG. 6 illustrates a flowchart of method 600 of training a neural network for anomaly detection according to another embodiment of the present disclosure. In step 610, a neural network for anomaly detection is trained based on EBLVM with a batch of sensing data samples of a plurality of component samples. For example, the component may be parts of products for assembling motor vehicle. The sensing data may be image data, sound data, or any other data captured by a sensor, such as, a camera, IR sensor, or ultrasonic sensor, etc. The training in step 610 may be performed according to the method 200 of FIG. 2 or method 3000 of FIG. 3.

After training the neural network, in step 620, the sensing data of a component to be detected is obtained through a corresponding sensor. In step 630, the obtained sensing data is input into the trained neural network. In step 640, reconstructed sensing data is obtained based on an output from the trained neural network with respect to the input sensing data. In step 650, the difference between the input sensing data and the reconstructed sensing data is determined. Then, in step 660, the determined difference is compared with a predetermined threshold, and if the determined difference is above the threshold, the component to be detected may be identified as an abnormal component. In this embodiment, the sensing data samples for training may be completely from good or normal component samples. The neural network completely trained with good data samples may be used to tell the differences between defect components and good components.

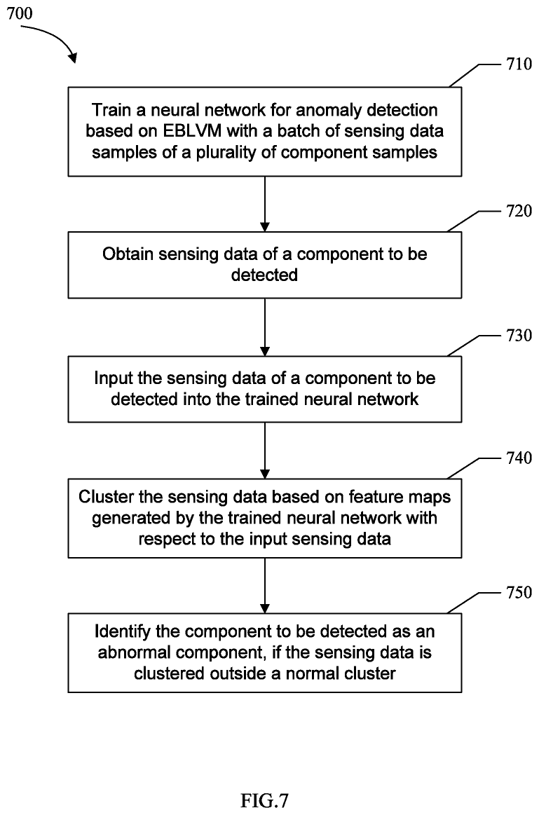

FIG. 7 illustrates a flowchart of method 700 of training a neural network for anomaly detection according to another embodiment of the present disclosure. In step 710, a neural network for anomaly detection is trained based on EBLVM with a batch of sensing data samples of a plurality of component samples. For example, the component may be parts of products for assembling motor vehicle. The sensing data may be image data, sound data, or any other data captured by a sensor, such as, a camera, IR sensor, or ultrasonic sensor, etc. The training in step 710 may be performed according to the method 200 of FIG. 2 or method 3000 of FIG. 3.

After training the neural network, in step 720, the sensing data of a component to be detected is obtained through a corresponding sensor. In step 730, the obtained sensing data is input into the trained neural network. In step 740, the sensing data is clustered based on feature maps generated by the trained neural network with respect to the input sensing data. In one embodiment, method 700 may comprise clustering the feature maps of the sensing data by unsupervised learning methods, such as, K-means. In step 750, if the sensing data is clustered outside a normal cluster, such as, clustered into a cluster with fewer training data samples, the component to be detected may be identified as an abnormal component. For example, as shown in FIG. 8, the circle dots are the batch of sensing data samples of a plurality of component samples, and the oval area may be defined as a normal cluster. The component to be detected denoted by a triangle may be identified as an abnormal component, since it is outside the normal cluster.

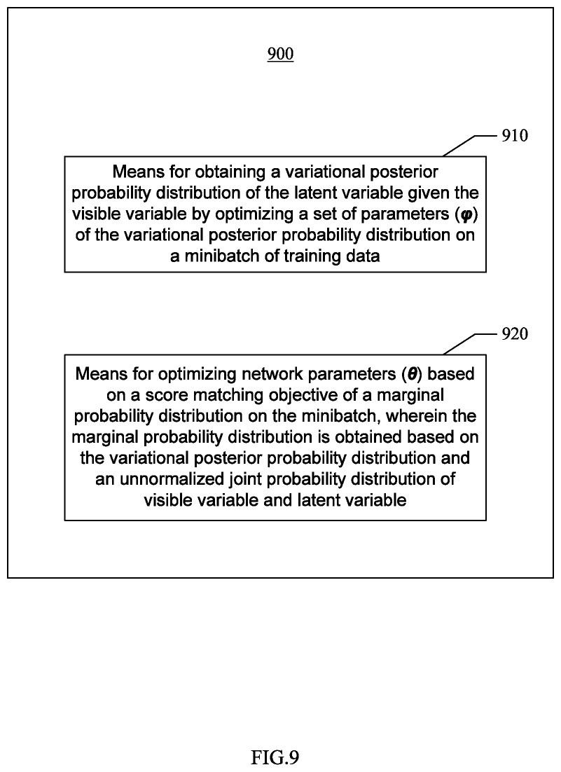

FIG. 9 illustrates a block diagram of an apparatus 900 for training a neural network based on an energy-based model with a batch of training data according to one embodiment of the present disclosure. The energy-based model may be an EBLVM defined by a set of network parameters (θ), a visible variable and a latent variable. As shown in FIG. 9, the apparatus 900 comprises means 910 for obtaining a variational posterior probability distribution of the latent variable given the visible variable by optimizing a set of parameters (φ) of the variational posterior probability distribution on a minibatch of training data; and means 920 for optimizing network parameters (θ) based on a score matching objective of a marginal probability distribution on the minibatch, wherein the marginal probability distribution is obtained based on the variational posterior probability distribution and an unnormalized joint probability distribution of visible variable and latent variable. The means 910 for obtaining a variational posterior probability distribution and the means 920 for optimizing network parameters (θ) are configured to perform repeatedly on different minibatches of training data, till convergence condition satisfied.

Although not shown in FIG. 9, apparatus 900 may comprise means for performing various steps of method 3000 as described in connection with FIG. 3. For example, the means 910 for obtaining a variational posterior probability distribution may be configured to perform steps 3110-3140 of method 3000, and the means 920 for optimizing network parameters (θ) may be configured to perform steps 3210-3250 of method 3000. In addition, apparatus 900 may further comprise means for performing anomaly detection as described in connection with FIGS. 5-7 according to various embodiments of the present disclosure, and the batch of training data may comprise a batch of sensing data samples of a plurality of component sample. The means 910 and 920 as well as the others of apparatus 900 may be implemented by software modules, firmware modules, hardware modules, or a combination thereof.

In one embodiment, the apparatus 900 may further comprise: means for obtaining sensing data of a component to be detected; means for inputting the sensing data of a component to be detected into the trained neural network; means for obtaining a density value based on an output from the trained neural network with respect to the input sensing data; and means for identifying the component to be detected as an abnormal component, if the density value is below a threshold.

In another embodiment, the apparatus 900 may further comprise: means for obtaining sensing data of a component to be detected; means for inputting the sensing data of a component to be detected into the trained neural network; means for obtaining reconstructed sensing data based on an output from the trained neural network with respect to the input sensing data; means for determining a difference between the input sensing data and the reconstructed sensing data; and means for identifying the component to be detected as an abnormal component, if the determined difference is above a threshold.

In another embodiment, the apparatus 900 may further comprise: means for obtaining sensing data of a component to be detected; means for inputting the sensing data of the component to be detected into the trained neural network; means for clustering the sensing data based on feature maps generated by the trained neural network with respect to the input sensing data; and means for identifying the component to be detected as an abnormal component, if the sensing data is clustered outside a normal cluster.

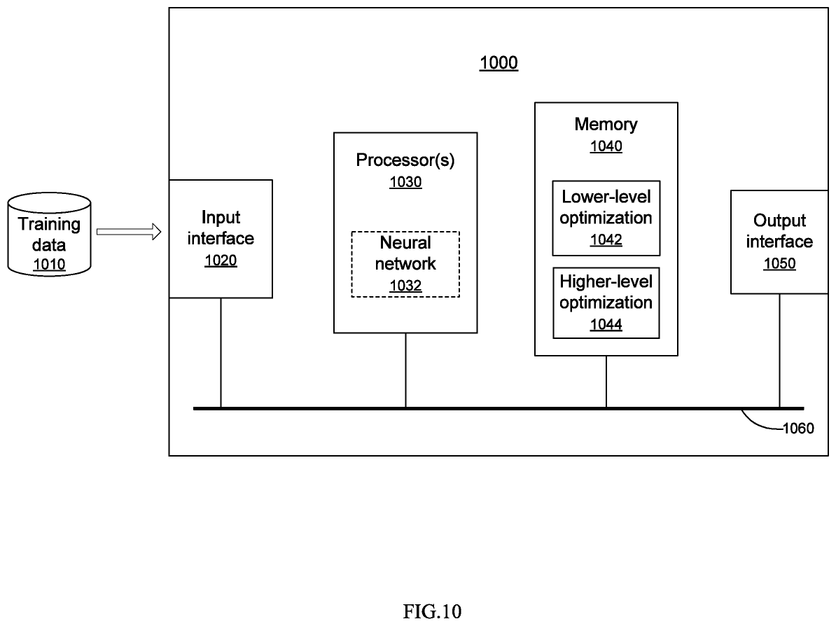

FIG. 10 illustrates a block diagram of an apparatus 1000 for training a neural network based on an energy-based model with a batch of training data according to another embodiment of the present disclosure. The energy-based model may be an EBLVM defined by a set of network parameters (θ), a visible variable and a latent variable. As shown in FIG. 10, the apparatus 1000 may comprise an input interface 1020, one or more processors 1030, memory 1040, and an output interface 1050, which are coupled between each other via a system bus 1060.

The input interface 1020 may be configured to receive training data from a database 1010. The input interface 1020 may also be configured to receive training data, such as, image data, video data, and audio data, directly from a camera, a microphone, or various sensors, such as IR sensor and ultrasonic sensor. The input interface 1020 may also be configured to receive actual data after the training stage. The input interface 1020 may further comprise user interface (such as, keyboard, mouse) for receiving inputs (such as, control instructions) from a user. The output interface 1050 may be configured to provide results processed by apparatus 1000 during and/or after the training stage, to a display, a printer, or a device controlled by apparatus 1000. In various embodiments, the input interface 1020 and the output interface 1050 may be but not limited to USB interface, Type-C interface, HDMI interface, VGA interface, or any other dedicated interface, etc.

As shown in FIG. 10, the memory 1040 may comprise a lower-level optimization module 1042 and a higher-level optimization module 1044. At least one processor 1030 is coupled to the memory 1040 via the system bus 1060. In one embodiment, the at least one processor 1030 may be configured to execute the lower-level optimization module 1042 to obtain a variational posterior probability distribution of the latent variable given the visible variable by optimizing a set of parameters (φ) of the variational posterior probability distribution on a minibatch of training data sampled from the batch of training data, wherein the variational posterior probability distribution is provided to approximate a true posterior probability distribution of the latent variable given the visible variable wherein the true posterior probability distribution is relevant to the network parameters (θ). The at least one processor 1030 may be configured to execute the higher-level optimization module 1044 to optimize network parameters (θ) based on a score matching objective of a marginal probability distribution on the minibatch of training data, wherein the marginal probability distribution is obtained based on the variational posterior probability distribution and an unnormalized joint probability distribution of the visible variable and the latent variable. And, the at least one processor 1030 may be configured to repeatedly executing the lower-level optimization module 1042 and the higher-level optimization module 1044, till a convergence condition is satisfied.

The at least one processor 1030 may comprise but not limited to general processors, dedicated processors, or even application specific integrated circuits. In one embodiment, the at least one processor 1030 may comprise a neural processing core 1032 (as shown in FIG. 10), which is a specialized circuit that implements all the necessary control and arithmetic logic necessary to execute machine learning and/or inference of a neural network.

Although not shown in FIG. 10, the memory 1040 may further comprise any other modules, when executed by the at least one processor 1030, causing the at least one processor 1030 to perform the steps of method 3000 described above in connection with FIG. 3, as well as other various and/or equivalent embodiments according to the present disclosure. For example, the at least one processor 1030 may be configured to train a generative neural network on the MNIST in database 1010 according to the learning setting described above in connection with FIG. 4. In this example, the at least one processor 1030 may be configure to sample from the trained generative neural network. The output interface 1050 may provide on a display or to a printer the sampled natural images of hand-written digits, e.g. as shown in FIG. 4.

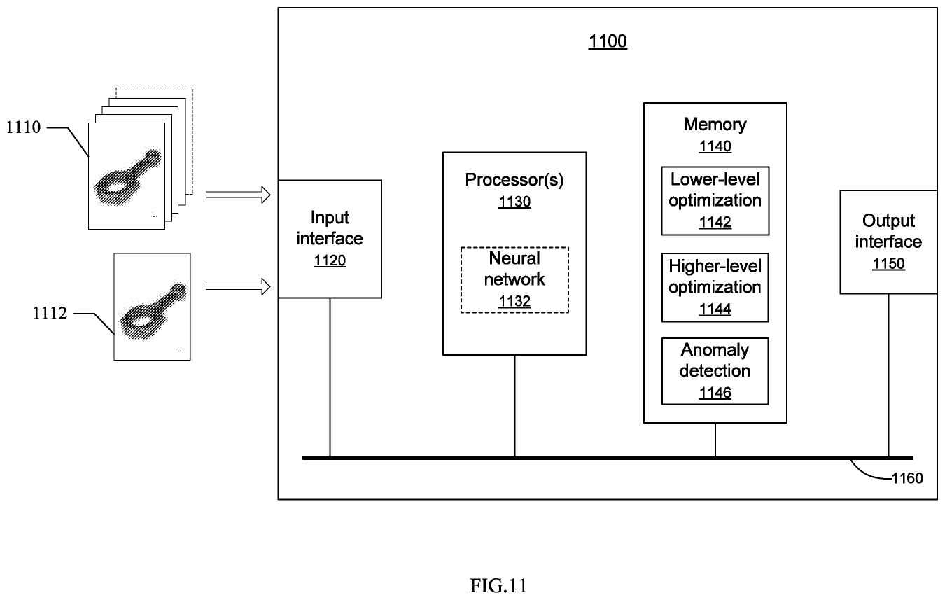

FIG. 11 illustrates a block diagram of an apparatus 1100 for training a neural network for anomaly detection based on an energy-based model with a batch of training data according to another embodiment of the present disclosure. The energy-based model may be an EBLVM defined by a set of network parameters (θ), a visible variable and a latent variable. As shown in FIG. 11, the apparatus 1100 may comprise an input interface 1120, one or more processors 1130, memory 1140, and an output interface 1150, which are coupled between each other via a system bus 1160. The input interface 1120, one or more processors 1130, memory 1140, output interface 1150 and bus 1160 may correspond to or may be similar with the input interface 1020, one or more processors 1030, memory 1040, output interface 1050 and bus 1060 in FIG. 10.

As compared to FIG. 10, the memory 1140 may further comprise an anomaly detection module 1146, when executed by the at least one processor 1130, causing the at least one process 1030 to perform anomaly detection as described in connection with FIGS. 5-7 according to various embodiments of the present disclosure. In one embodiment, during a training stage, the at least one process 1030 may be configured to receive a batch of sensing data samples of a plurality of component sample 1110 via input interface 1120. The sensing data may be image data, sound data, or any other data captured by a camera, a microphone, or a sensor, such as, IR sensor, or ultrasonic sensor, etc.

In one embodiment, after the training stage, the processor may be configured to: obtain sensing data of a component to be detected; input the sensing data of a component to be detected into the trained neural network; obtain a density value based on an output from the trained neural network with respect to the input sensing data; and identify the component to be detected as an abnormal component, if the density value is below a threshold.

In another embodiment, after the training stage, the processor may be configured to: obtain sensing data of a component to be detected; input the sensing data of a component to be detected into the trained neural network; obtain reconstructed sensing data based on an output from the trained neural network with respect to the input sensing data; determine a difference between the input sensing data and the reconstructed sensing data; and identify the component to be detected as an abnormal component, if the determined difference is above a threshold.

In another embodiment, after the training stage, the processor may be configured to: obtain sensing data of a component to be detected; input the sensing data of the component to be detected into the trained neural network; cluster the sensing data based on feature maps generated by the trained neural network with respect to the input sensing data; and identify the component to be detected as an abnormal component, if the sensing data is clustered outside a normal cluster.

The preceding description of the disclosed embodiments is provided to enable any person skilled in the art to make or use the various embodiments. Various modifications to these embodiments will be readily apparent to those skilled in the art, and the generic principles defined herein may be applied to other embodiments without departing from the scope of the various embodiments. Thus, the claims are not intended to be limited to the embodiments shown herein but is to be accorded the widest scope consistent with the following claims and the principles and novel features disclosed herein.

1. A method for training a neural network based on an energy-based model with a batch of training data, the energy-based model defined by a set of network parameters, a visible variable and a latent variable, the method comprising:
obtaining a variational posterior probability distribution of the latent variable given the visible variable by optimizing a set of parameters of the variational posterior probability distribution on a minibatch of the training data sampled from the batch of the training data, wherein the variational posterior probability distribution is provided to approximate a true posterior probability distribution of the latent variable given the visible variable, and wherein the true posterior probability distribution is relevant to the network parameters;
optimizing network parameters based on a score matching objective of a marginal probability distribution on the minibatch of training data, wherein the marginal probability distribution is obtained based on the variational posterior probability distribution and an unnormalized joint probability distribution of the visible variable and the latent variable; and
repeating the steps of obtaining the variational posterior probability distribution and optimizing network parameters on different minibatches of the training data, until a convergence condition is satisfied.

2. The method of claim 1, wherein optimizing the set of parameters of the variational posterior probability distribution is based on a divergence objective between the variational posterior probability distribution and the true posterior probability distribution and comprises repeating following steps for a number of K times, wherein K is an integer equal to or greater than zero:
calculating a stochastic gradient of the divergence objective under given network parameters; and
updating the set of parameters based on the calculated stochastic gradient by starting from an initialized or previously updated set of parameters.

3. The method of claim 1, wherein optimizing the network parameters comprises:
calculating the set of parameters as a function of the network parameters recursively for a number of N times by starting from an initialized or previously updated set of parameters, wherein N is an integer equal to or greater than zero;
obtaining an approximated stochastic gradient of the score matching objective based on the calculated set of parameters; and
updating the network parameters based on the approximated stochastic gradient.

4. The method of claim 1, wherein the variational posterior probability distribution is a Bernoulli distribution parameterized by a fully connected layer with sigmoid activation or a Gaussian distribution parameterized by a convolutional neural network.

5. The method of claim 1, wherein optimizing the set of parameters of the variational posterior probability distribution is performed based on an objective of minimizing Kullback-Leibler divergence or Fisher divergence between the variational posterior probability distribution and the true posterior probability distribution.

6. The method of claim 1, wherein the score matching objective is based at least in part on one of sliced score matching, denoising score matching, or multiscale denoising score matching.

7. The method of claim 1, wherein the training data comprises at least one of image data, video data, and audio data.

8. The method of claim 7, wherein the training data comprises sensing data samples of a plurality of component samples, and the method further comprises:
obtaining sensing data of a component to be detected;
inputting the sensing data of a component to be detected into the trained neural network;
obtaining a density value based on an output from the trained neural network with respect to the input sensing data; and
identifying the component to be detected as an abnormal component, if the density value is below a threshold.

9. The method of claim 7, wherein the training data comprises sensing data samples of a plurality of component samples, and the method further comprises:
obtaining sensing data of a component to be detected;
inputting the sensing data of a component to be detected into the trained neural network;
obtaining reconstructed sensing data based on an output from the trained neural network with respect to the input sensing data;
determining a difference between the input sensing data and the reconstructed sensing data; and
identifying the component to be detected as an abnormal component, if the determined difference is above a threshold.

10. The method of claim 7, wherein the training data comprises sensing data samples of a plurality of component samples, and the method further comprises:
obtaining sensing data of a component to be detected;
inputting the sensing data of the component to be detected into the trained neural network;
clustering the sensing data based on feature maps generated by the trained neural network with respect to the input sensing data; and
identifying the component to be detected as an abnormal component, if the sensing data is clustered outside a normal cluster.

11. An apparatus for training a neural network based on an energy-based model with a batch of training data, the energy-based model defined by a set of network parameters, a visible variable and a latent variable, the apparatus comprising:
means for obtaining a variational posterior probability distribution of the latent variable given the visible variable by optimizing a set of parameters of the variational posterior probability distribution on a minibatch of the training data sampled from the batch of training data, wherein the variational posterior probability distribution is provided to approximate a true posterior probability distribution of the latent variable given the visible variable, and wherein the true posterior probability distribution is relevant to the network parameters; and
means for optimizing network parameters based on a score matching objective of a marginal probability distribution on the minibatch of training data, wherein the marginal probability distribution is obtained based on the variational posterior probability distribution and an unnormalized joint probability distribution of the visible variable and the latent variable;
wherein the means for obtaining the variational posterior probability distribution and the means for optimizing network parameters are configured to perform repeatedly on different minibatches of the training data, until a convergence condition is satisfied.

12. The apparatus of claim 11, wherein the training data comprises sensing data samples of a plurality of component samples, and the apparatus further comprises:
means for obtaining sensing data of a component to be detected;
means for inputting the sensing data of a component to be detected into the trained neural network;
means for obtaining a density value based on an output from the trained neural network with respect to the input sensing data; and
means for identifying the component to be detected as an abnormal component, if the density value is below a threshold.

13. The apparatus of claim 11, wherein the training data comprises sensing data samples of a plurality of component samples, and the apparatus further comprises:
means for obtaining sensing data of a component to be detected;
means for inputting the sensing data of a component to be detected into the trained neural network;
means for obtaining reconstructed sensing data based on an output from the trained neural network with respect to the input sensing data;
means for determining a difference between the input sensing data and the reconstructed sensing data; and
means for identifying the component to be detected as an abnormal component, if the determined difference is above a threshold.

14. The apparatus of claim 11, wherein the training data comprises sensing data samples of a plurality of component samples, and the apparatus further comprises:
means for obtaining sensing data of a component to be detected;
means for inputting the sensing data of the component to be detected into the trained neural network;
means for clustering the sensing data based on feature maps generated by the trained neural network with respect to the input sensing data; and
means for identifying the component to be detected as an abnormal component, if the sensing data is clustered outside a normal cluster.

15. An apparatus for training a neural network based on an energy-based model with a batch of training data, the energy-based model defined by a set of network parameters, a visible variable and a latent variable, the apparatus comprising:
a memory; and
at least one processor coupled to the memory and configured to:
obtain a variational posterior probability distribution of the latent variable given the visible variable by optimizing a set of parameters of the variational posterior probability distribution on a minibatch of the training data sampled from the batch of the training data, wherein the variational posterior probability distribution is provided to approximate a true posterior probability distribution of the latent variable given the visible variable, and wherein the true posterior probability distribution is relevant to the network parameters;
optimize network parameters based on a score matching objective of a marginal probability distribution on the minibatch of training data, wherein the marginal probability distribution is obtained based on the variational posterior probability distribution and an unnormalized joint probability distribution of the visible variable and the latent variable; and
repeat the obtaining the variational posterior probability distribution and the optimizing network parameters on different minibatches of the training data, until a convergence condition is satisfied.

16. The apparatus of claim 15, wherein the training data comprises sensing data samples of a plurality of component samples, and the processor is further configured to:
obtain sensing data of a component to be detected;
input the sensing data of a component to be detected into the trained neural network;
obtain a density value based on an output from the trained neural network with respect to the input sensing data; and
identify the component to be detected as an abnormal component, if the density value is below a threshold.

17. The apparatus of claim 15, wherein the training data comprises sensing data samples of a plurality of component samples, and the processor is further configured to:
obtain sensing data of a component to be detected;
input the sensing data of a component to be detected into the trained neural network;
obtain reconstructed sensing data based on an output from the trained neural network with respect to the input sensing data;
determine a difference between the input sensing data and the reconstructed sensing data; and
identify the component to be detected as an abnormal component, if the determined difference is above a threshold.

18. The apparatus of claim 15, wherein the training data comprises sensing data samples of a plurality of component samples, and the processor is further configured to:
obtain sensing data of a component to be detected;
input the sensing data of the component to be detected into the trained neural network;
cluster the sensing data based on feature maps generated by the trained neural network with respect to the input sensing data; and
identify the component to be detected as an abnormal component, if the sensing data is clustered outside a normal cluster.

19. (canceled)
